(19) United States
(12) Patent Application Publication
(10) Pub. No.: US 2015/0291254 A1
(43) Pub. Date: Oct. 15, 2015

(54) SYSTEM AND METHOD FOR CONTROLLING MOTOR OF ELECTRIC BICYCLE

(71) Applicant: SAMSUNG ELECTRO-MECHANICS CO., LTD., Gyeonggi-Do (KR)

(72) Inventors: Geun Hong LEE, Gyeonggi-Do (KR); Kyeoung Hun PARK, Gyeonggi-Do (KR); Han Tae KIM, Gyeonggi-Do (KR); Changsung Sean KIM, Gyeonggi-Do (KR)

(73) Assignee: SAMSUNG ELECTRO-MECHANICS CO., LTD., Gyeonggi-Do (KR)

(21) Appl. No.: 14/329,485

(22) Filed: Jul. 11, 2014

(30) Foreign Application Priority Data
Apr. 11, 2014 (KR) 10-2014-0043768

(51) Int. Cl. B62M 6/50; B60L 3/00

(52) U.S. Cl. CPC B62M 6/50; B60L 3/00

(57) ABSTRACT

Embodiments of the invention provide a method and system for controlling a motor of an electric bicycle. According to various embodiments, the system includes a touch sensor positioned in a handle of the electric bicycle, configured to sense whether or not a user has touched the touch sensor, and configured to output a touch signal, and a controller configured to control driving of a driving motor. The controller is further configured to drive the driving motor only in the case in which the user's touch is sensed from the touch sensor.

### CROSS REFERENCE TO RELATED APPLICATION

This application claims the benefit of and priority under 35 U.S.C. §119 to Korean Patent Application No. KR 10-2014-0043768, entitled “SYSTEM AND METHOD FOR CONTROLLING MOTOR OF ELECTRIC BICYCLE,” filed on Apr. 11, 2014, which is hereby incorporated by reference in its entirety into this application.

### BACKGROUND

1. Field of the Invention

The present invention relates to a system and a method for controlling a motor of an electric bicycle.

2. Description of the Related Art

A bicycle includes a front wheel, which is a steering wheel, and a rear wheel, which is a driving wheel, disposed at the front and the rear of a frame, respectively, in a straight line, and a rider presses a pedal interlocking with the rear wheel to rotate the rear wheel, thereby moving the bicycle forward. The bicycle is provided with a power-transferring device, such as a chain or a gear, as non-limiting examples, transferring power generated from the pedal to the rear wheel.

Particularly, a power-transferring device in a chain scheme is configured to include a driving sprocket installed at one side of the pedal, a driven sprocket having a diameter smaller than that of the driving sprocket and installed at the rear wheel, which is the driving wheel, and a chain connecting the driving sprocket and the driven sprocket to each other.

Therefore, according to the configuration as described above, when the rider presses the pedal, the driving sprocket installed integrally with the pedal rotates. At the same time, the rear wheel connected to the driven sprocket by the chain also rotates, such that the bicycle moves forward.

The bicycle as described above, which is driven using pedal effort by pedaling of a user, does not have a difficulty in being driven on a flat land, but requires large force when it goes up a ramp, such as a slope, for example.

In order to solve this problem, an electric bicycle including a motor mounted therein, so that it may be driven using driving force of the motor in addition to the pedal effort of the user has been recently developed.

Thus, the motor driven by a battery is used in the electric bicycle. The electric bicycle as described above is configured to be driven only by force of the user pressing the pedal, be driven only by force of the motor driven by the battery, or be driven by both of the force of the user pressing the pedal and the force of the motor driven by the battery.

However, an electric bicycle according to the conventional art, for example, as described in Korean Patent Publication No. KR 10-2012-0132593 has a problem in that an accident occurs due to sudden unintended acceleration in the case in which a driving motor is operated regardless of intension of a user in a state in which the user does not completely grasp a handle, when the electric bicycle is driven by the battery.

### SUMMARY

Accordingly, embodiments of the invention have been made to provide a system and a method for controlling a motor of an electric bicycle capable of preventing the electric bicycle from moving in a state in which a driver does not completely grasp a handle.

According to an embodiment of the invention, there is provided a system for controlling a motor of an electric bicycle, the system including a touch sensor positioned in a handle of the electric bicycle, sensing whether or not a user has touched the touch sensor, and outputting a touch signal, and a controller controlling driving of a driving motor. According to an embodiment, the controller drives the driving motor only in the case in which a user's touch is sensed from the touch sensor.

According to an embodiment, the touch sensor is a capacitive type touch sensor.

According to an embodiment, a plurality of touch sensors are provided and positioned at left and right handles of the electric bicycle, respectively, and the controller drives the driving motor only in the case in which the user's touch is sensed by all of the plurality of touch sensors.

According to an embodiment, the system further includes a speed detector detecting a driving speed of the electric bicycle.

According to an embodiment, the controller further controls the driving of the driving motor depending on a driving speed value of the electric bicycle detected by the speed detector, and stops the driving of the driving motor in a stop state in which the driving speed of the electric bicycle is zero.

According to an embodiment, the controller further controls the driving of the driving motor depending on a driving speed value of the electric bicycle detected by the speed detector, and drives the driving motor only in a driving state in which the driving speed of the electric bicycle is more than zero.

According to an embodiment, the speed detector includes a three-axis acceleration sensor.

According to an embodiment, the system further includes a starter receiving a turn on/off condition for starting of the electric bicycle and outputting a starting signal, wherein the controller drives the driving motor only in the case in which the user's touch is sensed by the touch sensor and the turn on condition is input from the starter.

According to an embodiment, the controllers stops the driving of the driving motor regardless of whether or not the touch sensor has been touched when the starter is in the turn off condition.

According to an embodiment, the started is further formed of a turn on/off switch.

According to another embodiment of the invention, there is provided a method for controlling a motor of an electric bicycle, including a touch-sensing step of sensing whether or not a user has touched a touch sensor positioned in a handle of the electric bicycle from the touch sensor; and a controlling step of controlling driving of a driving motor. According to an embodiment, in the controlling step, the driving of the driving motor is controlled only in the case in which the user's touch is sensed from the touch sensor.

According to an embodiment, the touch sensor is a capacitive type touch sensor.

According to an embodiment, in the touch-sensing step, the user's touch is sensed from a plurality of touch sensors provided at left and right handles of the electric bicycle, respectively, and in the controlling step, the driving motor is driven only in the case in which the user's touch has been sensed by all of the plurality of touch sensors.

According to an embodiment, the method further includes a speed-detecting step of detecting a driving speed of the electric bicycle through a speed detector.

According to an embodiment, in the controlling step, the driving of the driving motor is controlled depending on a driving speed value of the electric bicycle detected by the speed detector, and the driving of the driving motor is stopped in a stop state in which the driving speed of the electric bicycle is zero.

According to an embodiment, in the controlling step, the driving of the driving motor is controlled depending on a driving speed value of the electric bicycle detected by the speed detector, and the driving motor may be driven only in a driving state in which the driving speed of the electric bicycle is more than zero.

According to an embodiment, the speed detector includes a three-axis acceleration sensor.

According to an embodiment, the method further includes a starting condition inputting step of receiving a turn on/off condition for starting input from a started provided in the electric bicycle.

According to an embodiment, in the controlling step, the driving motor is driven only in the case in which the touch sensor senses the user's touch and the turn on condition is input from the starter.

According to an embodiment, the starter is formed of a turn on/off switch.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is an illustrative diagram showing an electric bicycle in which a system for controlling a motor of an electric bicycle according to an embodiment of the invention is used.

FIG. 2 is a configuration diagram showing the system for controlling a motor of an electric bicycle according to an embodiment of the invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

Hereinafter, various embodiments of the present invention will be described in detail with reference to the accompanying drawings.

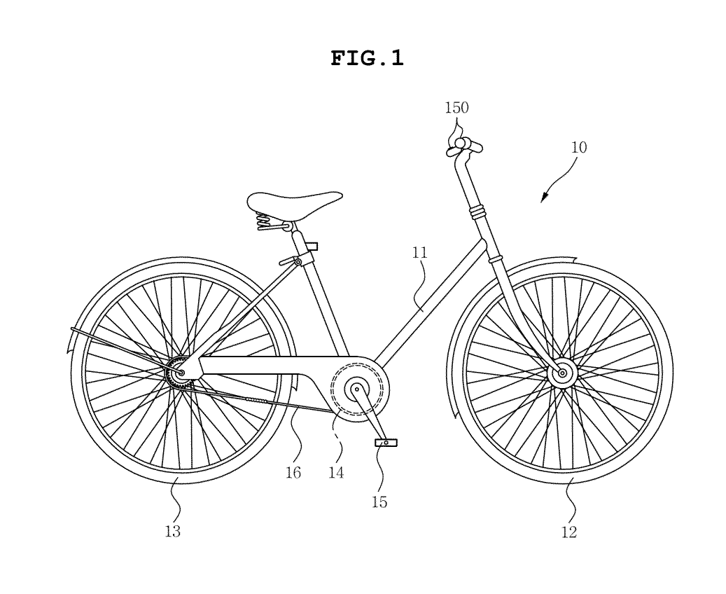

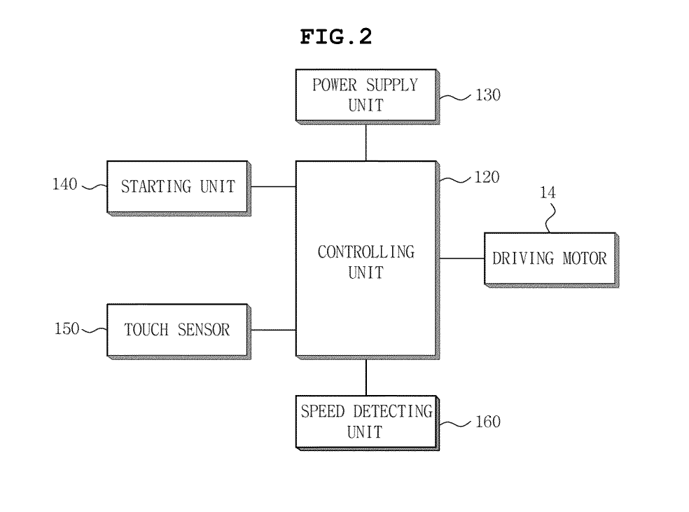

FIG. 1 is an illustrative diagram showing an electric bicycle in which a system for controlling a motor of an electric bicycle according to an embodiment of the invention is used, and FIG. 2 is a configuration diagram showing the system for controlling a motor of an electric bicycle according to an embodiment of the invention.

Referring to FIGS. 1 and 2, the system for controlling a motor of an electric bicycle 10 according to an embodiment of the invention includes a starter 140, a touch sensor 150, and a controller 120 and controls driving of a driving motor 14.

According to an embodiment, first, in the electric bicycle 10, a front wheel 12 and a rear wheel 13 are supported by a frame 11, and a chain 16 rotated by a power-transferring means is engaged with the rear wheel 13. According to an embodiment, the power-transferring means includes, for example, a pedal 15 and a driving motor 14. The pedal 15 transfers rotational force generated by rotation thereof, when force is applied thereto by a user to the chain 16. According to an embodiment, the driving motor 14 is connected to a power supply 130 and transfers rotational force to the chain 16 while rotating a shaft thereof, when power is supplied thereto. According to an embodiment, when force is applied to the pedal 15 by the user to drive the electric bicycle 10, the driving motor 14 assists the pedal 15 to make it easy to drive the electric bicycle 10 on a sloop, for example, even through the user applies small power to the pedal 15.

According to an embodiment, since a detailed configuration transferring the rotational force to the chain 16 through the pedal 15 or the driving motor 14 has been well known, a detailed description thereof will be omitted.

According to an embodiment, the starter 140 is provided, for example, in the frame 11 or a handle 17 of the electric bicycle 10, receives a turn on/off condition for starting of the electric bicycle 10, and outputs a starting signal.

In addition, the starter 140 is formed, for example, of a turn on/off switch. However, in the system for controlling a motor of an electric bicycle according to an embodiment of the invention, the starter 140 is not necessarily limited to being formed of the turn on/off switch. Here, for example, when a driver (i.e., user) positions the turn on/off switch of the starter 140 in a turn on state, the starter 140 outputs a starting signal value of the turn on state and transfer the starting signal value to the controller 120.

According to an embodiment, the touch sensor 150 is positioned in the handle 17 of the electric bicycle 10, senses whether or not the driver has touched the touch sensor, and outputs a touch signal.

According to an embodiment, a plurality of touch sensors 150 are provided and positioned at left and right handles 17 of the electric bicycle 10, respectively, to sense whether or not both hands of the driver have touched the handles 17.

According to an embodiment, the touch sensor 150 is provided along an outer surface of the handle 17 to detect whether or not the driver has completely grasped the handle 17 with his/her hands. Here, for example, when it is sensed by the touch sensor 150 mounted in the handle 17 that only a portion, such as a spot form has been touched, the controller 120 estimates that the hand of the driver has not completely grasped the handle 17.

According to an embodiment, when it is sensed that the hand of the driver has touched an entire region or a large region of the touch sensor 150, the controller 120 estimates that the hand of the driver has completely grasped the handle 17.

According to an embodiment, as an example, when the driver's touch is sensed in a region less than 30% of a region of an outer surface of the touch sensor 150, the controller 120 estimates that the hand of the driver has not completely grasped the handle 17, and when the driver's touch is sensed in a region of 70% or more of the region of the outer surface of the touch sensor 150, the controller 120 estimates that the hand of the driver has completely grasped the handle 17. However, a method in which the controller 120 included in the system for controlling a motor of an electric bicycle 10 according to an embodiment of the invention judges whether or not the driver has completely grasped the handle 17 is not necessarily limited thereto.

Meanwhile, the touch sensor 150 is, for example, a capacitive type touch sensor 150. According to an embodiment, the capacitive type touch sensor 150 contains any one or more of an indium tin oxide, a conductive polymer, and a metal mesh as a material of a transparent electrode, as non-limiting examples.

According to an embodiment, the controller 120 controls the driving of the driving motor 14 depending on the touch signal value input from the touch sensor 150 and the starting signal value input from the starter 140. Here, the driving motor 14 receives electricity from the power supply 130, and a turn on/off of an electrical connection and an amount of received electricity are controlled by the controller 120. According to an embodiment, the power supply 120 is formed of, for example, a battery.

According to an embodiment, the controller 120 drives the driving motor 14 only in the case in which the user's touch is sensed by the plurality of touch sensors 150 and a turn on condition is input from the starter 140.

Further, the controller 120 drives the driving motor 14 only in the case in which the user's touch is sensed by one or all of the plurality of touch sensors 150 in a state in which the driver inputs the turn on condition for the starting through the starter 140. According to an embodiment, the controller 120 does not drive the driving motor 14 when the starter 140 is in a turn off condition for the starting.

Meanwhile, the controller 120 does not drive the driving motor 14 in a stop state in which a driving speed of the electric bicycle 10 is zero, and drives the driving motor 14 in a driving state in which the driving speed of the electric bicycle 10 is 0 or more.

According to an embodiment, the system for controlling a motor of an electric bicycle according to an embodiment of the invention further include a speed detector 160 detecting a driving speed of the electric bicycle 10. According to an embodiment, the controller 120 receives a driving speed value of the electric bicycle 10 from the speed detector 160.

According to an embodiment, in addition, the speed detector 160 includes a three-axis acceleration sensor. The three-axis acceleration sensor measures accelerations of x, y, and z axes to sense a gradient of the electric bicycle 10 and an acceleration of the electric bicycle 10. In addition, the three-axis acceleration sensor is, for example, a gyro sensor, but not limited thereto.

Hereinafter, a method for controlling a motor of an electric bicycle according to an embodiment of the invention will be described in detail with reference to FIGS. 1 and 2.

According to an embodiment, the method for controlling a motor of an electric bicycle according to an embodiment of the invention relates to a control method for the system for controlling a motor of an electric bicycle according to an embodiment of the invention.

Referring to FIGS. 1 and 2, the method for controlling a motor of an electric bicycle according to an embodiment of the invention includes a starting condition inputting step, a touch-sensing step, and a controlling step of the electric bicycle 10.

In detail, in the starting condition inputting step, a turn on/off condition for starting is received from the starter 140 provided in the electric bicycle 10. According to an embodiment, the starter 140 is formed of, for example, a turn on/off switch. When a driver operates the turn on/off switch in a turn on state, the controller 120 receives a starting signal value in the turn on state from the starter 140. However, in the method for controlling a motor of an electric bicycle 10 according to an embodiment of the invention, the starter 140 is not necessarily limited to being formed of the turn on/off switch.

In the touch-sensing step, it is sensed from the touch sensor 150 positioned in the handle 17 of the electric bicycle 10 whether or not the driver has touched touch sensor 150. According to an embodiment, a plurality of touch sensors 150 are provided and positioned at left and right handles 17 of the electric bicycle 10, respectively. Therefore, in the touch-sensing step, the plurality of touch sensors 150 sense whether or not the driver has touched the touch sensors 150, such that it is sensed whether the driver has grasped both of the left and right handles 17 of the electric bicycle 10.

According to an embodiment, the touch sensor 150 is, for example, a capacitive type touch sensor 150, but is not limited thereto. According to an embodiment, the capacitive type touch sensor 150 contains any one or more of an indium tin oxide, a conductive polymer, and a metal mesh as a material of a transparent electrode, as non-limiting examples.

According to an embodiment, in the controlling step, the controller 120 controls the driving of the driving motor 14 depending on the starting signal value input from the starter 140 and the touch signal value input from the touch sensor 150.

According to an embodiment, in addition, in the controlling step, the driving motor 14 is driven only in the case in which the user's touch is sensed by the touch sensor 150 and a turn on condition is input from the starter 140.

According to an embodiment, in this case, in the controlling step, the driving motor 14 is driven only in the case in which the user's touch is sensed by the touch sensors 150 and the turn on condition is input from the starter 140. For example, in the controlling step, when the number of touch sensors 150 is plural, the driving motor 14 is configured only in the case in which the user's touch is sensed by all of the plurality of touch sensors 150.

Meanwhile, in the controlling step, the driving of the driving motor 14 is stopped through the controller 120 regardless of whether or not the touch sensor 150 has been touched, when the starter 140 is in a turn off condition.

According to an embodiment, in addition, in the controlling step, the driving of the driving motor 14 is controlled through the controller 120 depending on whether or not the touch sensor 150 has been touched at the time of initial driving of the electric bicycle 10, when the starter 140 is in a turn on condition for the starting.

Meanwhile, when the touch sensor 150 is provided on an outer surface of the handle 17 to detect the driver's touch in the touch-sensing step and then transmits the touch signal value to the controller 120, it is judged through the controller 120 in the controlling step whether or not the driver has completely grasped the handle 17 with his/her hands.

According to an embodiment, for example, when it is sensed by the touch sensor 150 mounted in the handle 17 in the touch-sensing step that only a portion such as a spot form has been touched, it is judged through the controller 120 in the controlling step that the hand of the driver has not completely grasped the handle 17.

According to an embodiment, in addition, when it is sensed in the touch-sensing step that the hand of the driver has touched an entire region or a large region of the touch sensor 150 provided along an outer peripheral surface of the handle 17, it is estimated through the controller 120 in the controlling step that the hand of the driver has completely grasped the handle 17.

According to an embodiment, as an example, when it is sensed in the touch-sensing step that the driver's touch is sensed in a region less than 30% of a region of an outer surface of the touch sensor 150, it is estimated through the controller 120 in the controlling step that the hand of the driver has not completely grasped the handle 17. In addition, when it is sensed in the touch-sensing step that the driver's touch is sensed in a region of 70% or more of the region of the outer surface of the touch sensor 150, it is estimated through the controller 120 in the controlling step that the hand of the driver has completely grasped the handle 17. However, a method of judging whether the user has completely grasped the handle 17 in the controlling step of the system for controlling a motor of an electric bicycle 10 according to an embodiment of the invention is not necessarily limited thereto.

Meanwhile, in the controlling step, the driving motor 14 is not driven in a stop state in which a driving speed of the electric bicycle 10 is zero, and is driven in a driving state in which the driving speed of the electric bicycle 10 is 0 or more.

According to an embodiment, the method for controlling a motor of an electric bicycle according to an embodiment of the invention further includes a speed detector of detecting a driving speed of the electric bicycle 10 through the speed detector 160. According to an embodiment, in the controlling step, the driving speed value of the electric bicycle 10 detected from the speed detector 160 in the speed-detecting step is received to control the driving of the driving motor 14.

According to an embodiment, in addition, the speed detector 160 includes a three-axis acceleration sensor. According to an embodiment, the three-axis acceleration sensor measures accelerations of x, y, and z axes to sense a gradient of the electric bicycle 10 and an acceleration of the electric bicycle 10. In addition, the three-axis acceleration sensor is, for example, a gyro sensor.

According to various embodiments of the invention, the touch sensor senses whether or not the driver has grasped the handle, and the controller drives the driving motor of the electric bicycle only in the case in which the driver grasps the handle, thereby making it possible to prevent movement of the electric bicycle due to driving of the driving motor of the electric bicycle in a state in which the driver does not completely grasp the handle. Therefore, an accident of the driver due to sudden unintended acceleration may be prevented.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A system for controlling a motor of an electric bicycle, the system comprising:
a touch sensor positioned in a handle of the electric bicycle, configured to sense whether or not a user has touched the touch sensor, and configured to output a touch signal; and
a controller configured to control driving of a driving motor,
wherein the controller is further configured to drive the driving motor only in the case in which the user's touch is sensed from the touch sensor.

2. The system as set forth in claim 1, wherein the touch sensor is a capacitive type touch sensor.

3. The system as set forth in claim 1, wherein a plurality of touch sensors are provided and positioned at left and right handles of the electric bicycle, respectively, and
the controller is further configured to drive the driving motor only in the case in which the user's touch is sensed by all of the plurality of touch sensors.

4. The system as set forth in claim 1, further comprising:
a speed detector configured to detect a driving speed of the electric bicycle.

5. The system as set forth in claim 4, wherein the controller is further configured to control the driving of the driving motor depending on a driving speed value of the electric bicycle detected by the speed detector, and further configured to stop the driving of the driving motor in a stop state in which the driving speed of the electric bicycle is zero.

6. The system as set forth in claim 4, wherein the controller is further configured to control the driving of the driving motor depending on a driving speed value of the electric bicycle detected by the speed detector, and further configured to drive the driving motor only in a driving state in which the driving speed of the electric bicycle is more than zero.

7. The system as set forth in claim 4, wherein the speed detector comprises a three-axis acceleration sensor.

8. The system as set forth in claim 1, further comprising:
a starter configured to receive a turn on/off condition for starting of the electric bicycle and to output a starting signal,
wherein the controller is further configured to drive the driving motor only in the case in which the user's touch is sensed by the touch sensor and the turn on condition is input from the starter.

9. The system as set forth in claim 8, wherein the controller is further configured to stop the driving of the driving motor regardless of whether or not the touch sensor has been touched, when the starter is in the turn off condition.

10. The system as set forth in claim 8, wherein the starter is formed of a turn on/off switch.

11. A method for controlling a motor of an electric bicycle, the method comprising:
a touch-sensing step of sensing whether or not a user has touched a touch sensor positioned in a handle of the electric bicycle from the touch sensor; and
a controlling step of controlling driving of a driving motor,
wherein, in the controlling step, the driving of the driving motor is controlled only in the case in which the user's touch is sensed from the touch sensor.

12. The method as set forth in claim 11, wherein the touch sensor is a capacitive type touch sensor.

13. The method as set forth in claim 11, wherein in the touch-sensing step, it is sensed from a plurality of touch sensors provided at left and right handles of the electric bicycle, respectively, that the user has touched the touch sensors, and
in the controlling step, the driving motor is driven only in the case in which the user's touch has been sensed by all of the plurality of touch sensors.

14. The method as set forth in claim 11, further comprising:
a speed detecting step of detecting a driving speed of the electric bicycle through a speed detector.

15. The method as set forth in claim 14, wherein in the controlling step, the driving of the driving motor is controlled depending on a driving speed value of the electric bicycle detected by the speed detector, and the driving of the driving motor is stopped in a stop state in which the driving speed of the electric bicycle is zero.

16. The method as set forth in claim 14, wherein in the controlling step, the driving of the driving motor is controlled depending on a driving speed value of the electric bicycle detected by the speed detector, and the driving motor is driven only in a driving state in which the driving speed of the electric bicycle is more than zero.

17. The method as set forth in claim 14, wherein the speed detector comprises a three-axis acceleration sensor.

18. The method as set forth in claim 11, further comprising:
a starting condition inputting step of receiving a turn on/off condition for starting input from a starter provided in the electric bicycle.

19. The method as set forth in claim 18, wherein in the controlling step, the driving motor is driven only in the case in which the user's touch is sensed by the touch sensor and the turn on condition is input from the starter

20. The method as set forth in claim 18, wherein the starter is formed of a turn on/off switch.
